(19) United States
(12) Patent Application Publication
(10) Pub. No.: US 2016/0150919 A1
(43) Pub. Date: Jun. 2, 2016

(54) VOICE ACTIVATED SELF CLEANING SHOWER

(71) Applicant: MARK DICKSON, Orangeburg, SC (US)

(72) Inventor: MARK DICKSON, Orangeburg, SC (US)

(21) Appl. No.: 14/557,390

(22) Filed: Dec. 1, 2014

(51) Int. Cl. A47K 3/28; B05B 12/00

(52) U.S. Cl. CPC A47K 3/281; B05B 12/00

(57) ABSTRACT

The invention is a shower that will clean itself. This new shower is voice activated, and the user will be able to set the water temperature, and the level of water desired in the bathtub without having to turn the water-supply handles. The Voice Activated Self Cleaning Shower is designed to make life much easier for everyone, especially those who have physical or visual limitations that make it difficult to scrub showers and tubs. It is emphasized that this abstract is provided to comply with the rules requiring an abstract that will allow a searcher or other reader to quickly ascertain the subject matter of the technical disclosure.

### BACKGROUND OF THE INVENTION

1. Field of the Invention

The inventive device disclosed in the present application generally relates to shower devices and more specifically to a self cleaning shower system.

2. Brief Description of the Prior Art

Self cleaning shower systems are well known in the art. For example, U.S. Pat. No. 5,452,485 to Ross discloses and claims a gliding tub and shower cleaning device for automatically cleaning a bath tub and a shower stall. The device consists of a control center, a tub glider and a shower glider. The tub and shower gliders have brushes attached and are connected to drive systems which move the gliders around the inside of the shower stall and the bathtub on tracks.

In addition to that, U.S. Pat. No. 4,383,341 to Altman discloses and claims a bathtub self-cleaning system includes a series of pop-out spray nozzles designed to be arranged about the confining walls of a bathtub and the like. The spray nozzles are connected by a manifold to a combined concentrate and dilutent mixing control valve. The control valve of the Altman device serves to initially mix the dilutent such as water with the concentrate such as a detergent to provide a diluted cleaning solution.

U.S. Pat. No. 6,742,199 to Conway and Kaiser discloses and claims, an automatic shower and bathtub cleaning device, with no connection to the water supply piping, that directs cleaning fluid through nozzles that are positioned or adjusted to allow coverage of the entire inside surface of the shower or bathtub enclosure. The device disclosed by Conway and Kaiser consists of a main body, cleaning fluid reservoir, electric pump, nozzles, and a control circuit that allows either local or remote initiation of the device's cleaning cycle operation.

U.S. Pat. No. 7,980,713 to Nielsen discloses and claims, an elongated lighting strip is provided. Under the teachings of Nielsen's patent, the lighting strip is positioned inside of a shower or bathtub enclosure in order to both illuminate the enclosure as well as spray or diffuse and aqueous solution onto the enclosure.

Finally, U.S. Published Patent Application No. 20050166945 by Whitmore discloses, a cleaning system for automatically cleaning a shower and a method of operating thereof is described. The Whitmore cleaning system comprises a cleaning solution reservoir configured to hold a cleaning solution; a fluid dispensing device configured to dispense the cleaning solution within the shower; a pumping system coupled to the cleaning solution reservoir and configured to supply the cleaning solution from the cleaning solution reservoir to the fluid dispensing device; and a power source coupled to the pumping system, and configured to provide the pumping system with power for pumping the cleaning solution.

Despite all the efforts listed above prior art patents describe structures that are either not truly convenient or else involve complicated, expensive, and overly difficult assembly and/or disassembly parts and procedures. Other devices have been advertised on various media but never patented or described into a printed publication.

### SUMMARY OF THE INVENTION

The inventive device disclosed in the present application is a shower that will clean itself. This new shower is voice activated, and the user will be able to set the water temperature, and the level of water desired in the bathtub without having to turn the water-supply handles.

It is then the principal object of the present invention is to provide an easy way to clean the shower and tub after each use. It is a secondary objective of the present invention to eliminate the need to scrub a dirty shower after the soap and dirt have dried.

It is an additional objective of the present invention to provide a device that will eliminate concerns about water running too long and overflowing the tub or being scalded or chilled by water that is not at a comfortable temperature. It is a final objective of the present invention to provide for a device that is relatively inexpensive to built and set up, but can eventually be sold at a premium.

These and other objective achieved by the device of the present invention will be apparent by the drawings, by their detailed description, and by the specification here from appended.

### BRIEF DESCRIPTION OF THE DRAWINGS

FIG. 1 is a front elevation view of one of the preferred embodiments of the “Voice Activated Self Cleaning Shower” in accordance with the teaching of the present invention.

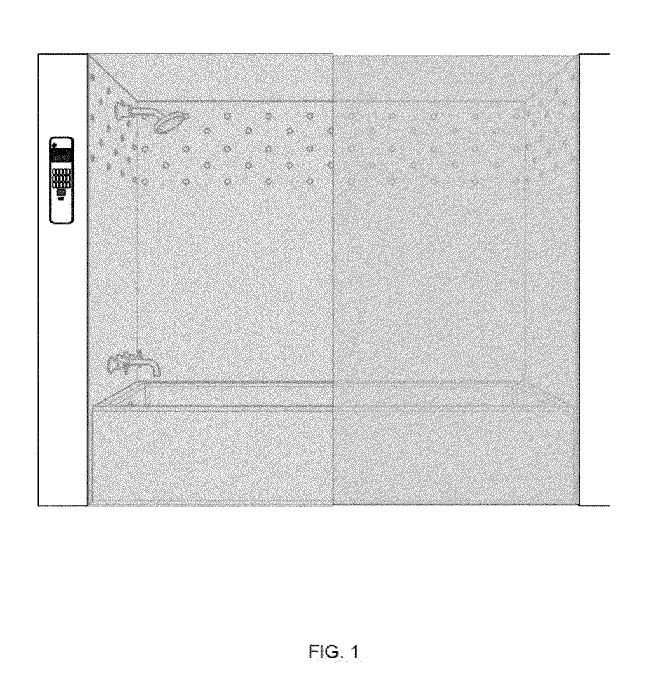

FIG. 2 is a front perspective view of “Voice Activated Self Cleaning Shower” of FIG. 1 and all its features.

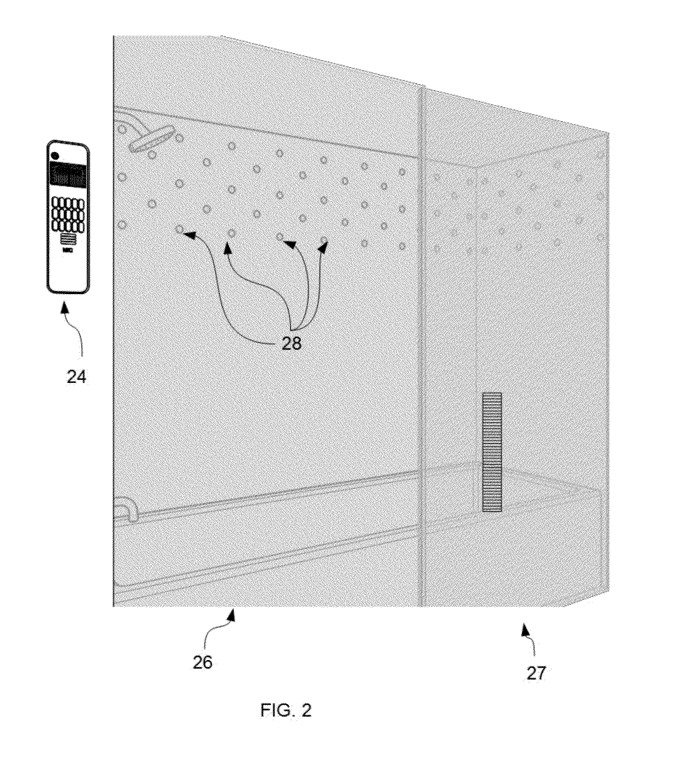

FIG. 3 is a detail closeup view of the remote control of the “Voice Activated Self Cleaning Shower” controller of FIGS. 1 and 2.

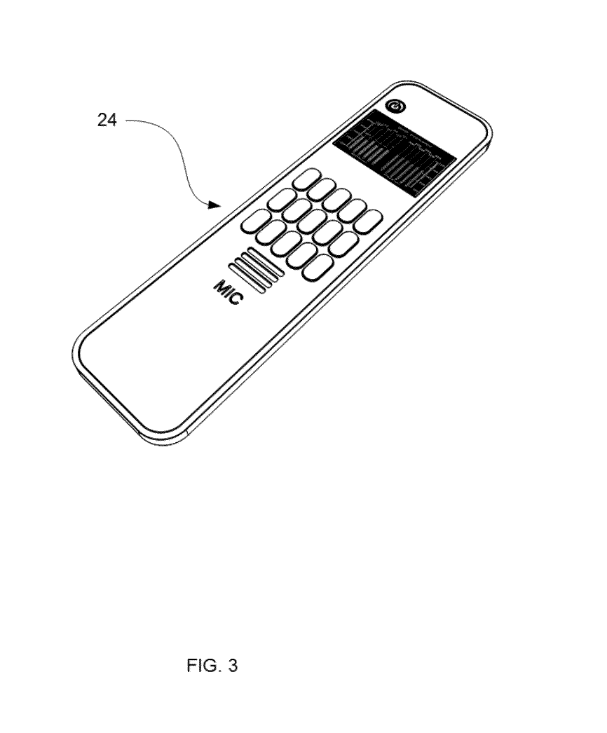

FIG. 4 is a diagrammatic view of a first preferred embodiment of the “Voice Activated Self Cleaning Shower” of the present application showing the major components of the inventive device and the functional relationships that link them to each other.

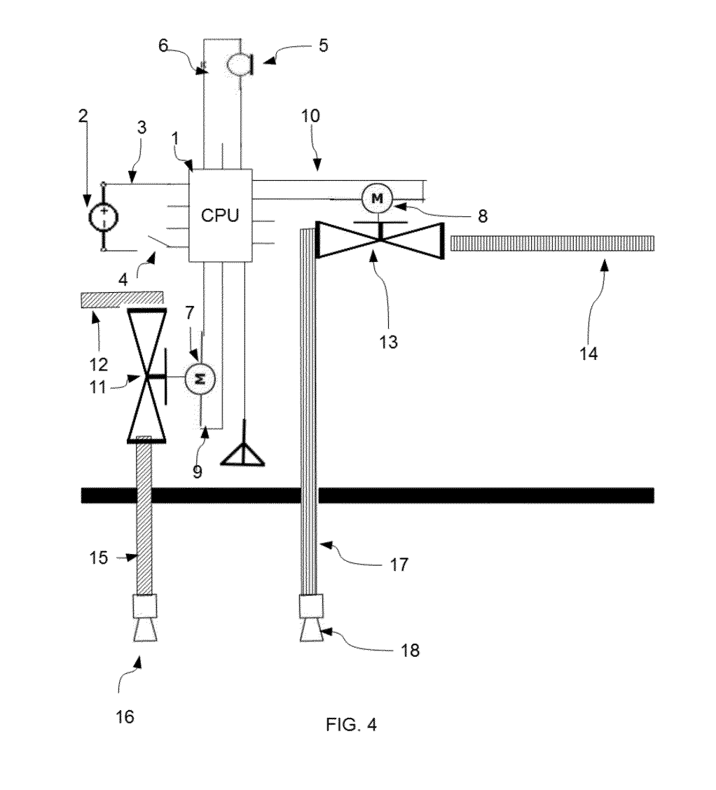

FIG. 5 is a diagrammatic view of a second preferred embodiment of the “Voice Activated Self Cleaning Shower” of the present application showing the mixer (19).

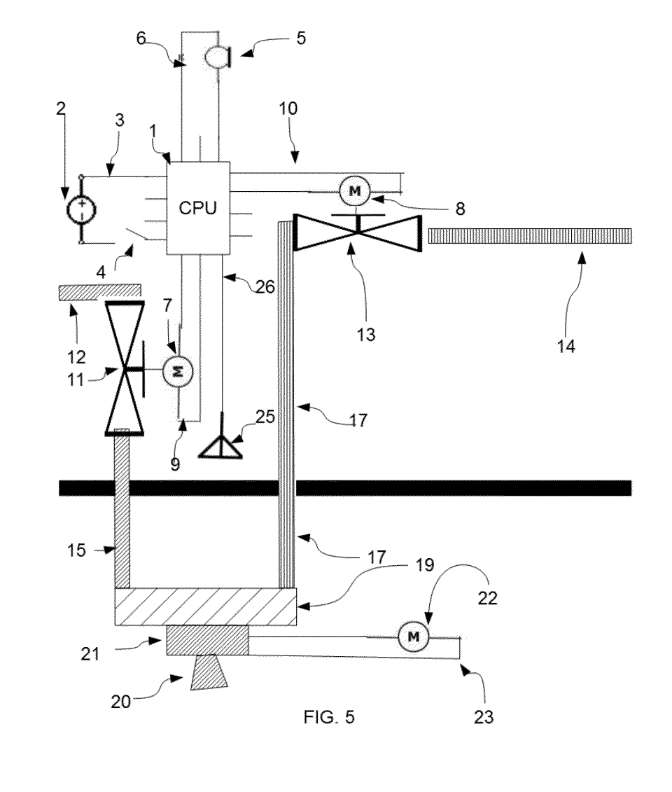

### DESCRIPTION OF THE PREFERRED EMBODIMENT

The invention is a shower that will clean itself. This new shower is voice activated, and the user can set the water temperature, and the level of water desired in the bathtub without having to turn the water-supply handles. A thermometer may be added to monitor the temperature of the water and transmit the information to a CPU via a sixth electrical circuitry.

The Voice Activated Self Cleaning Shower will make life much easier for everyone, especially those who have physical or visual limitations that make it difficult to scrub showers and tubs. When this new shower is installed, users will be able to control the water temperature and the duration of the shower by providing verbal instructions. When taking a bath, the user can set the level of water desired and the temperature in the same way.

They would still have the option to use the hand controls when needed. After finishing the shower or bath, the user can easily activate jets (28) around the three walls of the shower that will release water and a cleaning solution to rinse away the dirt and soap scum before it dries, leaving the shower and tub sparkling. A further embodiment of the present invention teaches a suap reserve activated by a CPU that releases soap at the same time or before that the jets of water begin spraying. The soap reserve may be cleaning soap, degreaser, or other combination of soaps to prevent the accumulation of dirt in the bath tub.

The doors of the shower are made of transparent glass, and the user will need to close these sliding doors so the front can be rinsed off as well. The controller or interface for the shower is mounted on the outside, next to the sliding glass doors (26 and 27). Consumers will be able to customize this shower to fit their bathrooms and choose the options they prefer.

In one of its preferred embodiments is a voice activates self cleaning shower system comprising a Central Processing Unit or CPU (1) powered by a voltage source (2) to wich is connected via a first electrical circuitry (3) having an ON/OFF switch (4); where said CPU runs a voice recognition software capable to recognize the voice input collected from a microphone (5) to which is connected via a second electrical circuitry (6); where said CPU elaborates the voice input collected from said microphone (5) into electrical pulses that regulates motor (7), and motor (8), respectively connected to said CPU via a third electical circuitry (9) and a fourth electrical circuitry (10); where said motors (7 & 8) respectively act on needle valve (11) on the cold water main (12) and needle valve (13) on the hot water main (14) thus regulating the flow of cold and hot mater through exit tube (15) and exit tube (17).

A central processing unit (CPU) is the hardware within a computer that carries out the instructions of a computer program by performing the basic arithmetical, logical, control and input/output operations of the system. The term has been in use in the computer industry at least since the early 1960s. The form, design, and implementation of CPUs have changed over the course of their history, but their fundamental operation remains much the same.

A computer can have more than one CPU; this is called multiprocessing. All modern CPUs are microprocessors, meaning contained on a single chip. Some integrated circuits (ICs) can contain multiple CPUs on a single chip; those ICs are called multi-core processors. An IC containing a CPU can also contain memory, peripheral devices, and other components of a computer system; this is called a system on a chip (SoC).

Two typical components of a CPU are the arithmetic logic unit (ALU), which performs arithmetic and logical operations, and the control unit (CU), which extracts instructions from memory and decodes and executes them, calling on the ALU when necessary. Not all computational systems rely on a central processing unit. An array processor or vector processor has multiple parallel computing elements, with no one unit considered the “center”. In the distributed computing model, problems are solved by a distributed interconnected set of processors.

A microphone, colloquially mic or mike is an acoustic-to-electric transducer or sensor that converts sound in air into an electrical signal. Microphones are used in many applications such as telephones, hearing aids, public address systems for concert halls and public events, motion picture production, live and recorded audio engineering, two-way radios, megaphones, radio and television broadcasting, and in computers for recording voice, speech recognition, VoIP, and for non-acoustic purposes such as ultrasonic checking or knock sensors.

Most microphones today use electromagnetic induction (dynamic microphones), capacitance change (condenser microphones) or piezoelectricity (piezoelectric microphones) to produce an electrical signal from air pressure variations. Microphones typically need to be connected to a preamplifier before the signal can be amplified with an audio power amplifier or recorded.

A noise-canceling microphone is a microphone that is designed to filter ambient noise from the desired sound, which is especially useful in noisy environments. The development is a special case of the differential microphone topology most commonly used to achieve directionality. All such microphones have at least two ports through which sound enters; a front port normally oriented toward the desired sound and another port that's more distant. The microphone's diaphragm is placed between the two ports; sound arriving from an ambient sound field reaches both ports more or less equally. Sound that's much closer to the front port than to the rear will make more of a pressure gradient between the front and back of the diaphragm, causing it to move more. The microphone's proximity effect is adjusted so that flat frequency response is achieved for sound sources very close to the front of the mic—typically 1 to 3 cm. Sounds arriving from other angles are subject to steep midrange and bass rolloff.

Another technique uses two or more microphones and active or passive circuitry to reduce the noise. The primary microphone is closer to the desired source (like a person's mouth). A second mic receives ambient noise. In a noisy environment, both microphones receive noise at a similar level, but the primary mic receives the desired sounds more strongly. Thus if one signal is subtracted from the other (in the simplest sense, by connecting the microphones out of phase) much of the noise is canceled while the desired sound is retained. Other techniques may be used as well, such as using a directional primary mic, to maximize the difference between the two signals and make the cancellation easier to do.

The internal electronic circuitry of an active noise-canceling mic attempts to subtract noise signal from the primary microphone. The circuit may employ passive or active noise canceling techniques to filter out the noise, producing an output signal that has a lower noise floor and a higher signal-to-noise ratio.

For the purpose of the present application speech recognition (SR) is the translation of spoken words into text. It is also known as “automatic speech recognition” (ASR), “computer speech recognition”, or just “speech to text” (STT).

Some SR systems use “speaker-independent speech recognition” while others use “training” where an individual speaker reads sections of text into the SR system. These systems analyze the person's specific voice and use it to fine-tune the recognition of that person's speech, resulting in more accurate transcription. Systems that do not use training are called “speaker-independent” systems. Systems that use training are called “speaker-dependent” systems.

Speech recognition applications include voice user interfaces such as voice dialling (e.g. “Call home”), call routing (e.g. “I would like to make a collect call”), domotic appliance control, search (e.g. find a podcast where particular words were spoken), simple data entry (e.g., entering a credit card number), preparation of structured documents (e.g. a radiology report), speech-to-text processing (e.g., word processors or emails), and aircraft (usually termed Direct Voice Input).

The term voice recognition or speaker identification refers to finding the identity of “who” is speaking, rather than what they are saying. Recognizing the speaker can simplify the task of translating speech in systems that have been trained on a specific person's voice or it can be used to authenticate or verify the identity of a speaker as part of a security process.

The voice activated self cleaning shower system of the present application may further comprise nozzle (16) and nozzle (18), or alternaitvely mixer (19) supporting rotating nozzle (20) over mechanical bearing system (21). Mechanical bearing system (21) is moved via an electical motor (22) electrically connected with said bearing system (21) by a fifth electrical circuitry (23). Nozzles (16)(18) and (20) may be delaval nozzles.

A nozzle is a device designed to control the direction or characteristics of a fluid flow (especially to increase velocity) as it exits (or enters) an enclosed chamber or pipe. A nozzle is often a pipe or tube of varying cross sectional area, and it can be used to direct or modify the flow of a fluid (liquid or gas). Nozzles are frequently used to control the rate of flow, speed, direction, mass, shape, and/or the pressure of the stream that emerges from them. In nozzle velocity of fluid increases on the expense of its pressure energy. A de Laval nozzle (or convergent-divergent nozzle, CD nozzle or con-di nozzle) is a tube that is pinched in the middle, making a carefully balanced, asymmetric hourglass-shape. It is used to accelerate a hot, pressurized gas passing through it to a supersonic speed, and upon expansion, to shape the exhaust flow so that the heat energy propelling the flow is maximally converted into directed kinetic energy. Because of this, the nozzle is widely used in some types of steam turbines, and is used as a rocket engine nozzle. It also sees use in supersonic jet engines.

The simplest apparatus in terms of nozzles is a tubular setup known as a Venturi tube or simply a venturi. Fluid flows through a length of pipe of varying diameter. To avoid undue drag, a Venturi tube typically has an entry cone of 30 degrees and an exit cone of 5 degrees. Venturi tubes are available in various sizes from 100 mm to 813 mm with flow coefficient value of 0.984 for all diameter ratios. They are widely used due to low permanent pressure loss. They are more accurate over wide flow ranges than orifice plates or flow nozzles. However it is not used where the Reynolds number is less than 150,000. Venturi tubes are used in processes where permanent pressure loss is required and where maximum accuracy is needed in case of high viscous liquids.

The CPU may be wiressly activated by remote control (24). The signal emitted by said remote control (24) is captured by an antenna (25) connected to said CPU by electrical connection (26).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A voice activates self cleaning shower system comprising a
a. CPU powered by
b. a voltage source to wich is connected via
c. a first electrical circuitry having
d. an ON/OFF switch; where said CPU runs a voice recognition software capable to recognize the voice input collected from
e. a microphone to which is connected via a
f. second electrical circuitry; where said CPU elaborates the voice input collected from said microphone into electrical pulses that regulates
g. a first motor, and
h. a second motor, respectively connected to said CPU via
i. a third electical circuitry and
l. a fourth electrical circuitry; where said motors respectively act on
m. needle valve on the cold water main and
n. needle valve on the
o. hot water main thus regulating the flow of cold and hot mater through
p. exit tube and
r. exit tube.

2. The voice activated self cleaning shower system of claim 1 further comprising nozzle and nozzle.

3. The voice activated self cleaning shower system of claim 1 further comprising mixer supporting rotating nozzle over mechanical bearing system.

4. The voice activated self cleaning shower system of claim 1 where said mechanical bearing system is moved via an electical motor electrically connected with said bearing system by a fifth electrical circuitry.

5. The voice activated self cleaning shower system of claim 1 where said CPU is activated by remote control.

6. The voice activated self cleaning shower system of claim 5 where the signal emitted by said remote control is captured by an antenna connected to said CPU by electrical connection.

7. The voice activated self cleaning shower system of claim 1 where said microphone is a noice canceling microphone.

8. The voice activated self cleaning shower system of claim 1 where said nozzles are delaval nozzles.

9. The voice activated self cleaning shower system of claim 4 where said nozzle is a delaval nozzle.

10. The voice activated self cleaning shower system of claim 1 where said nozzles are Venturi tubes.

11. The voice activated self cleaning shower system of claim 10 where said Venturi tubes have exit diameters in between 0.001 m and 0.813 m

12. The voice activated self cleaning shower system of claim 4 where said nozzle is a Venturi tube.

13. The voice activated self cleaning shower system of claim 12 where said Venturi tube has an exit diameter in between 0.001 m and 0.813 m.
